(19) United States
(12) Patent Application Publication
(10) Pub. No.: US 2003/0024384 A1
(43) Pub. Date: Feb. 6, 2003

(54) Oil-less/oil free air brake compressors

(75) Inventors: Val Dunaevsky, Fairview Park, OH (US); Gene Gilbert, Elyria, OH (US); Neil McMaster, Medina, OH (US)

Correspondence Address: CALFEE HALTER & GRISWOLD, LLP, 800 SUPERIOR AVENUE, SUITE 1400, CLEVELAND, OH, 44114, US

(73) Assignee: Honeywell Commercial Vehicle Systems Company

(21) Appl. No.: 09/923,026

(22) Filed: Aug. 6, 2001

(51) Int. Cl. F01B 31/10; B60T 8/42

(52) U.S. Cl. 92/157; 303/115.1

(57) ABSTRACT

A reciprocating air brake compressor includes a crank case housing a crank shaft and a piston assembly operatively connected to the crank shaft via a connecting rod. The piston assembly includes a piston moveable within a bore of the crank case, a piston ring disposed on a peripheral surface of the piston, and a wrist pin rotatably connecting the connecting rod to the piston. A means is provided for generating an air stream free of oil. In one embodiment, the means includes a channel extending through the crank shaft and connecting rod for delivering oil to the crank shaft and wrist pin bearings. The means further includes first and second sealing assemblies disposed adjacent the crank shaft and wrist pin bearings respectively. In another embodiment, the means includes crank shaft bearings and wrist pin bearings packed and sealed with grease. In another embodiment, the means includes crank shaft bearings packed and sealed with grease and wrist pin bearings and the piston ring being lubricated with a lubricant injected through a passage of the compressor.

### BACKGROUND OF THE INVENTION

1. Field of the Invention

The present invention relates to compressors used in heavy vehicle braking systems. More particularly, this invention is directed to an oil-less/oil free air brake compressor.

2. Discussion of the Art

Air compressors are used in brake systems to provide and maintain air under pressure to operate the vehicle brakes and any auxiliary air systems. The compressor is engine driven and typically is a two cylinder, single stage, reciprocating compressor. A connecting rod extends from the engine driven crankshaft and is operatively connected to a piston that reciprocates in an associated bore to compress the air in the bore and provide pressurized air to the brake system/auxiliary air system.

A typical vehicle engine provides a contiguous supply of oil to the compressor in order to lubricate the bearings and other components. The oil is routed from the engine to an oil inlet of the compressor to maintain lubrication of the connecting rod, crankshaft and wrist pin bearings as well as the piston rings and other dynamic components. In such systems, the oil is able to escape from all of the bearings and is mainly returned to the engine oil system. The pistons typically include a plurality of piston rings to seal with the bore wall. For example, commercial arrangements usually employ five (5) piston rings that, although seal the compression chamber, do not inhibit sufficiently oil, carried with the piston rings, from entering into the compression chamber and contaminating the air brake system.

When oil passes by the piston rings and enters the air stream, oil fouling occurs. This is a normal phenomenon accompanying operation of the lubricated air compressor. Oil fowling affects components of the air brake system which are susceptible to attack of oil containing harmful oil additives or ingredients of the engine fuel. In addition, oil may carbonize and lodge in the air passages, thus preventing the compressor from charging the air. Oil may also leak out of the compressor and contaminate the environment.

Furthermore, the presence of the engine oil in the compressed air complicates design of the air dryer by requiring the air dryer to have special oil filtering cartridges. The oil in the air dryer also can lead to premature dryer failure. Moreover, frequent purges of the air dryer, which contain oil residue, foul the environment. Finally, the dependence of the air brake compressor on engine drive and lubrication puts the compressor in a slavery dependence on the engine operating parameters which may not be beneficial for the compressor.

The foregoing shortcomings of oil lubricated compressors increase the warranty costs to manufacturers, increase the cost of ownership to the truck owners, and impact the environment which requires costly cleansing procedures.

In order to overcome these shortcomings, it is desirable to provide an air brake compressor that does not require oil for lubrication or which seals the oil from contaminating the air brake system and impacting the surrounding environment. Oil-less and oil free gas compressors are currently available to satisfy the needs of various non-brake applications. Oil-less compressors do not use oil for lubrication of the running components. Oil free compressors rely on oil for lubrication of some of the running components, typically the crank shaft and crank pin bearings.

For a variety of reasons, the foregoing commercial oil-less and oil free gas compressors can not be used as air brake compressors. First, the size capacities and performance characteristics of these compressors do not allow for them to be used as air brake compressors. Second, these non-brake compressors are designed to function at much more lenient operating conditions than air brake compressors. Thus, they would not be able to withstand the increased temperatures of an air brake environment. An estimated life of these gas compressors in the conditions of an air brake environment is less than 1/10 of the required compressor life. Third, the non-brake compressors do not have the sealing capabilities which are desired in air brake applications.

Accordingly, a continued need exists in the art to provide oil-less/oil free air compressors in the air brake industry.

### SUMMARY OF THE INVENTION

The present invention provides an oil-less/oil free compressor that meets the above needs and others in a simple and economical manner.

More particularly, the invention provides an air compressor, for supplying air to a vehicle brake system, comprised of a crank case housing a crank shaft and a piston assembly. The piston assembly is operatively connected to the crank shaft via a connecting rod. The piston assembly includes a piston moveable within a bore of the crank case and a wrist pin rotatably connecting the connecting rod to the piston. A means is provided for generating an air stream free of oil.

According to a proposed embodiment, the means for generating an air stream free of oil includes a channel extending through the crank shaft and connecting rod for delivering oil to crank shaft and wrist pin bearings. The means further includes first and second sealing assemblies disposed adjacent the crank shaft and wrist pin bearings respectively for preventing oil from leaking from the bearing assemblies.

According to another proposed embodiment, the means for generating an oil free air stream includes sealed crank shaft bearings and sealed wrist pin bearings packed with grease.

According to another proposed embodiment, the means for generating an oil free air stream includes sealed crank shaft bearings packed with grease. The means further includes wrist pin bearings and a piston ring lubricated with a lubricant injected into the compressor through a passage.

A primary benefit of the subject invention resides in the minimization of oil entering the air stream of an air brake compressor.

Another benefit of the subject invention resides in the reduction of oil leaking from an air brake compressor and impacting the environment.

Another benefit of the subject invention is the provision of reduced warranty and ownership costs associated with an air brake compressor.

Still another benefit of the subject invention is the provision of spring loaded lip seals which enhance the sealing of the crankshaft and wrist pin bearings.

Still another benefit of the subject invention resides in enhanced cooling, heat transfer and insulation characteristics which enable the compressor to withstand the elevated temperatures of an air brake system.

Still another benefit of the subject invention is the provision of a piston ring having improved sealing abilities.

Still other features and benefits of the invention will become apparent to those skilled in the art upon reading and understanding the following detailed description.

### BRIEF DESCRIPTION OF THE DRAWINGS

FIG. 1 is a cross sectional view of an oil free air brake compressor in accordance with one embodiment of the present invention;

FIG. 2a is a cross sectional view of a spring loaded lip seal engaging a crank shaft in accordance with the present invention;

FIG. 2b is plan view of a spring loaded lip seal in accordance with the present invention;

FIG. 3 is a cross sectional view of an oil free air brake compressor in accordance with another embodiment of the present invention;

FIG. 4 is a perspective view of an oil-less compressor partially cut away in accordance with the present invention;

FIG. 5 is a cross sectional view of the oil-less compressor of FIG. 4 in accordance with the present invention;

FIG. 6 is a plan view of a compression piston ring in accordance with the present invention; and

FIG. 7 is a plan view of a wrist pin having a polytetrafluoroethylene band in accordance with the present invention.

### DETAILED DESCRIPTION OF THE PREFERRED EMBODIMENTS

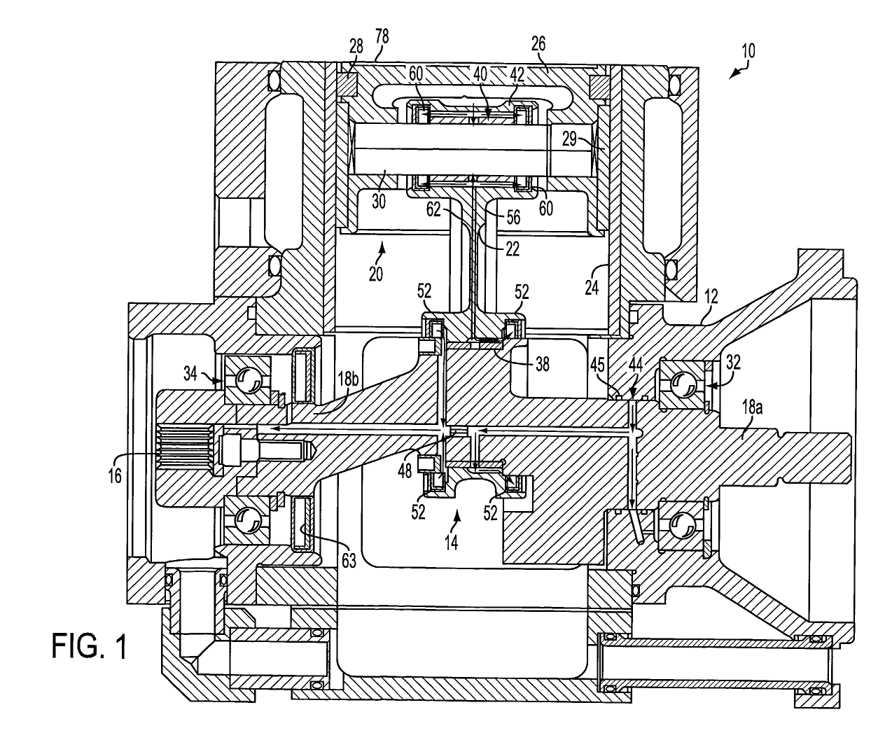

Turning first to FIG. 1, a first embodiment of the present invention includes a reciprocating oil free compressor 10 having a crank case 12 housing a crank shaft 14. The crank shaft is operatively connected to a power steering connector 16 which drives a power steering pump (not shown). The crank shaft includes a first front end 18a and a second rear end 18b. The crank shaft is driven by a vehicle engine (not shown) and typically operates in a continuous mode when the engine is running.

A piston assembly 20 is also housed by the crank case and is operatively connected to the crank shaft via a connecting rod 22. The piston assembly is positioned within a cylindrical bore 24 of the crank case and is configured to oscillate while the crank shaft rotates. As shown, the piston assembly includes a piston 26 and a compression piston ring 28 on the peripheral surface of the piston. The compression ring sealingly engages the internal wall defining the cylindrical bore. The piston assembly further includes a rider piston ring 29 and a wrist pin 30 disposed within the piston assembly. The rider ring and compression ring will be collectively referred to as the piston rings.

Front crank shaft bearings 32 and rear crank shaft bearings 34 are disposed at opposite ends of the crank shaft between the crank shaft and the crank case. The front and rear crank shaft bearings enable the crank shaft to freely rotate with respect to the crank case. The front and rear bearings are lubricated with oil. In a preferred embodiment, these bearings are conventional ball bearings. However, other types of bearings are contemplated by the present invention, such as journal bearings, needle bearings, etc.

The compressor is further provided with intermediate crank shaft bearings 38 disposed on an outer diameter of the crank shaft between the crank shaft and the connecting rod. In a preferred embodiment, the intermediate bearings are journal bearings lubricated with oil to allow free and substantially frictionless rotation of the crank shaft with respect to the connecting rod. The front, rear, and intermediate bearings will collectively be referred to as the crank shaft bearings. Although a journal bearing is shown as the intermediate crank shaft bearing, it must be appreciated that any other suitable bearing assembly is within the scope and intent of the present invention, such as ball bearings or needle bearings.

With continued reference to FIG. 1, the piston assembly includes wrist pin bearings 40 disposed between the wrist pin and an upper housing 42 of the connecting rod. The wrist pin bearings are lubricated with oil and allow free and substantially frictionless rotation of the connecting rod's upper housing. The wrist pin bearings are preferably journal or needle bearings, but may be any other suitable type of bearing assembly.

A closed loop or path, having a strategic oil sealing arrangement, is provided within the compressor for delivering oil from the engine to the crank shaft and wrist pin bearings. Such a closed loop system and sealing arrangement minimizes the possibility of oil escaping from the bearings and contaminating the air stream and impacting the surrounding environment. The loop includes an inlet 44 where the oil is initially fed into the compressor. Two O-rings 45 seal oil on each side of the inlet 44. From the inlet, the oil travels into the crank shaft and toward the intermediate crank shaft bearings 38. A restrictor 48 forces the oil to travel into the intermediate crank shaft bearings where the intermediate bearings are lubricated.

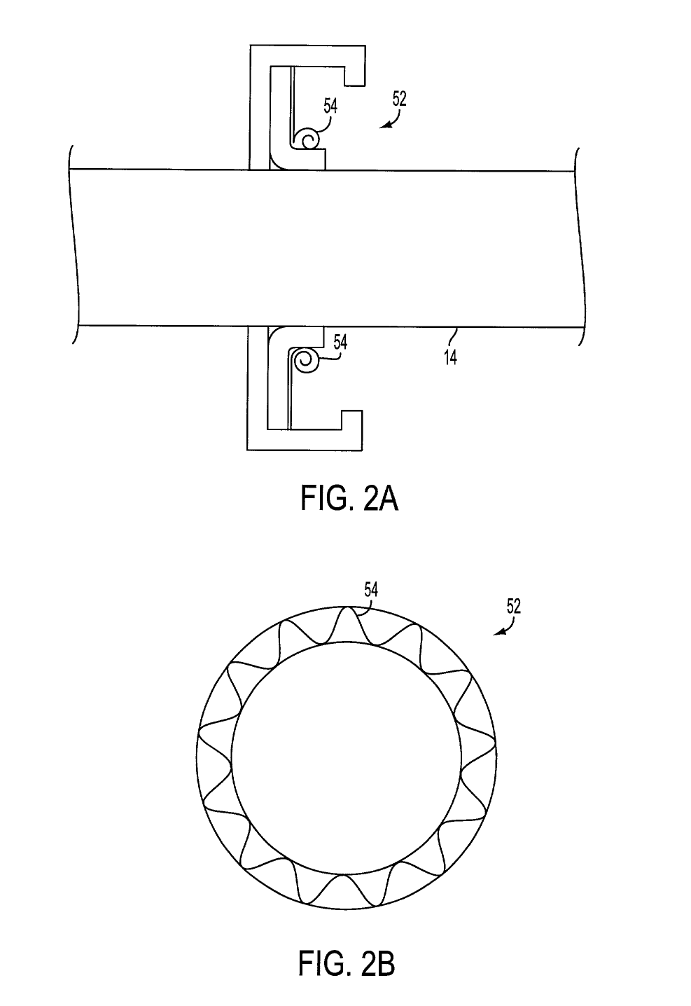

A first sealing assembly is provided adjacent the intermediate crank shaft bearings in order to prevent oil from escaping into the air stream and surrounding environment. The sealing assembly includes seals 52 on either side of the crank shaft. The seals are preferably concentrically disposed around the crank shaft. In a preferred embodiment, the seals are lip seals made from an elastic or elastomeric material, such as rubber. Lip seals are preferred over O-rings because they have better conformability. Although the lip seals shown are preferred, any other suitable seals are within the scope and intent of the present invention. With reference also to FIGS. 2a and 2b, the lip seals may be spring loaded in order to continuously urge the lip seals against the crank shaft, thus providing a better seal. The spring loaded lip seals include a spring 54 arranged concentrically within the seals which provides a continuous radial force to the crank shaft.

From the intermediate crank shaft bearings 38, the oil travels through a supply channel 56 of the connecting rod 22 toward the wrist pin bearings 40 where the wrist pin bearings are lubricated. The wrist pin bearings include a second sealing assembly for preventing oil from escaping into the air stream and surrounding environment. The second sealing assembly includes seals 60 on either side of the wrist pin bearings. Seals 60 are preferably lip seals which may be spring loaded. However, any other suitable seals are contemplated by the present invention.

After lubricating the wrist pin bearings, the oil travels through a return channel 62, built into the periphery side of the connecting rod, and back into the crank shaft. The oil then exits at the rear end 18b of the crank shaft. A seal 63, similar to seals 52, prevents the existing oil from spilling back into the crank case. In this embodiment, the piston rings 28 and 29 are not lubricated. Instead, the piston rings are made from self lubricating materials, for example, such as a filled polytetrafluoroethylene—PTFE.

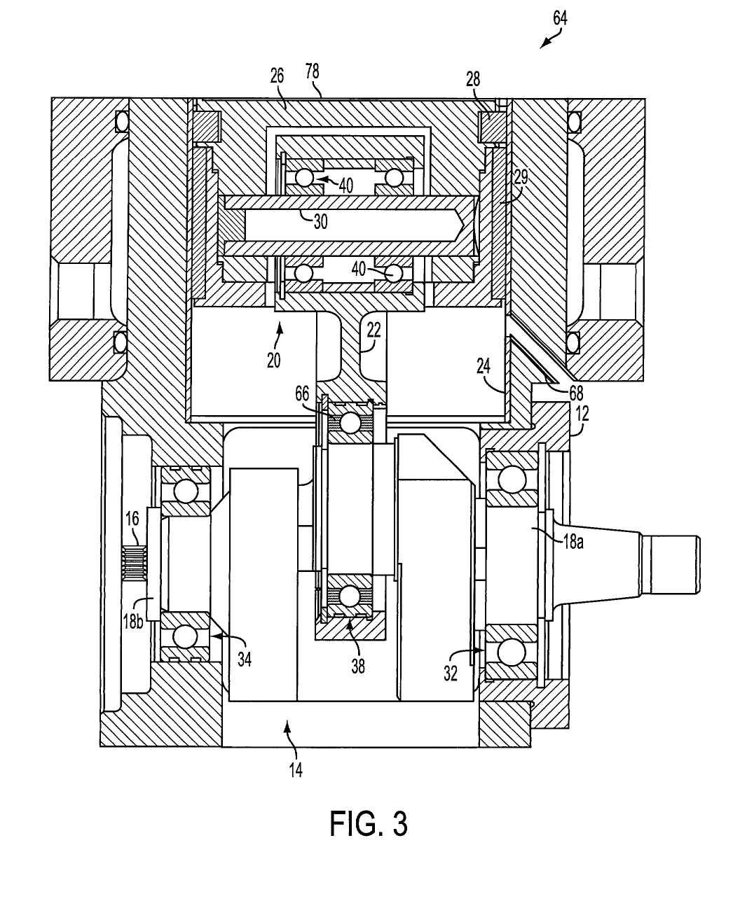

With reference to FIG. 3, a second embodiment of the present invention includes an oil free reciprocating compressor 64 which is similar to the compressor of the first embodiment. With regard to the first and second embodiments, and for purposes of brevity, like numerals represent like components and new numerals identify new components. In this embodiment, there are no channels provided throughout the crank shaft 14 and connecting rod 22 for delivering oil to the crank shaft and wrist pin bearings. Rather, the crank shaft bearings 32, 34, and 38 are sealed and filled with grease 66 which is easier to contain than oil. The wrist pin 30 and piston rings are lubricated with oil injected through a passage 68. This ensures a reduced amount of oil entering the air stream. Alternatively, the wrist pin and connecting rod can be lubricated with a limited amount of engine fuel or coolant. In either event, the piston, piston rings and inner surface of the compressor bore are preferably made or coated with a low friction ceramic material.

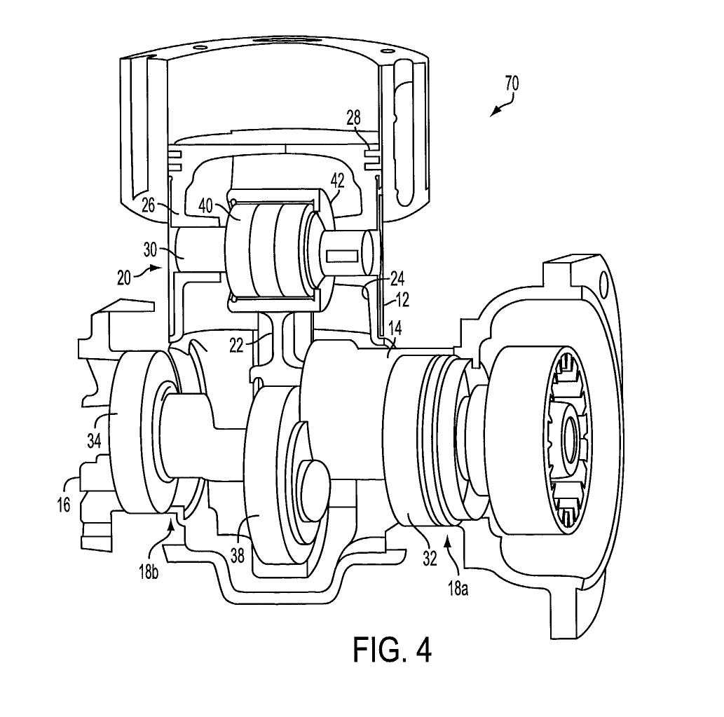

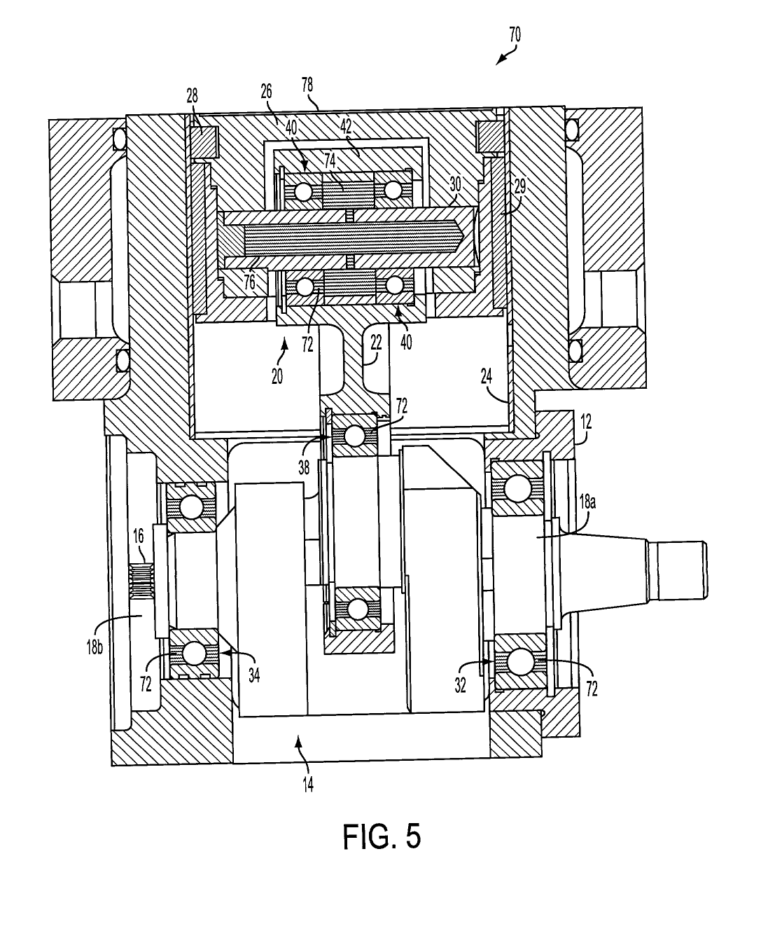

Turning now to FIGS. 4 and 5, a third embodiment of the present invention includes an oil-less reciprocating compressor 70 wherein, again, like numerals represent like elements. The detailed description associated with the embodiment of FIG. 1 applies unless specifically noted to the contrary.

The crank shaft and wrist pin rolling bearings are packed or filled with grease 72. Seals (not shown in FIGS. 4 and 5) are provided around the grease packed bearings to prevent the grease from escaping. Any suitable seals are within the scope and intent of the present invention. The wrist pin bearings are preferably spaced from each other to form a gap 74 containing extra grease (see FIG. 5). Moreover, the wrist pin may be provided with a bore 76 containing extra grease. This extra grease replaces the grease that gradually degrades and/or escapes from the wrist pin bearings. The compression piston ring 28 and rider piston ring 29 are made from a self lubricating material, such as filled PTFE, for example. Accordingly, no oil is used for the compressor of this embodiment, thereby eliminating the potential for oil contaminating the air stream.

Each of the above oil-less and oil free compressor embodiments include several common components and features which make them well suited for air brake environments. More specifically, each of the compressors in the foregoing embodiments preferably includes a ceramic coating 78 on an upper surface of the piston for heat insulation of the wrist pin bearings, the lubricant, and the seals (see FIGS. 1, 3 and 5). Such a ceramic coating reduces the temperature of the bearings, seals and lubricant, thus prolonging their life.

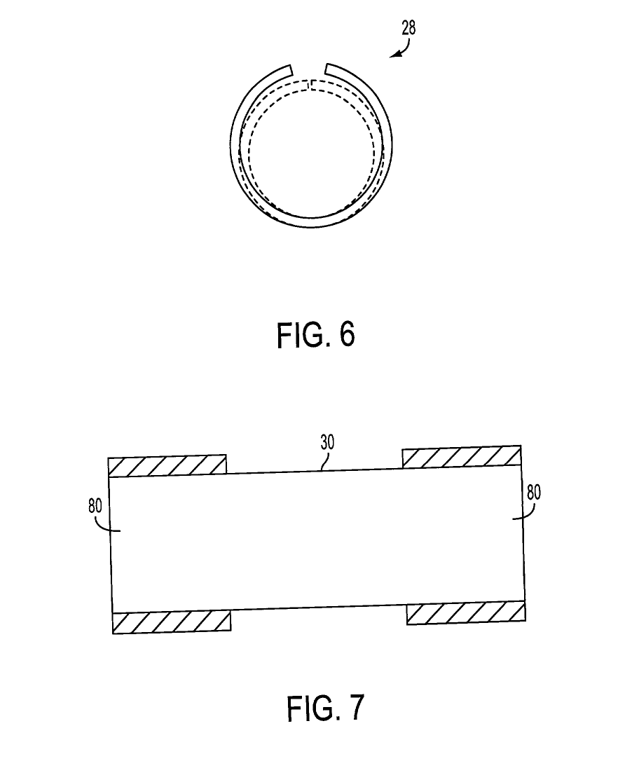

Moreover, each of the above compressors preferably includes an elastic compression piston ring 28 which in its free state (not enclosed by the compressor bore 24) has an out of round shape and a diameter larger than the inside diameter of the compressor bore (see FIG. 6). The ring preferably has a non-uniform oval shape and is split to allow its perimeter to change under an applied force. When the piston ring 28 is placed in the compressor bore and is reduced in diameter, it is continuously urged against the inner sidewalls of the compressor bore, even without a gas pressure, which provides enhanced sealing functions.

The compression piston ring 28 of the foregoing embodiments may advantageously comprise a single compression ring (see FIG. 5) as opposed to two thin rings (see FIG. 4). The single compression ring is preferably as thick axially as the two thin rings comprising conventional compression rings. The single ring is preferably made from a filled PTFE. The extra thickness of the ring improves resistance of the ring to thermal distortions. Also, the ring is of sufficient volume to compensate for wear.

With regard to the wrist pin 30 of the foregoing embodiments, it is preferable to make the wrist pin from or coat the wrist pin with zirconium. This enhances the heat insulating features of the wrist pin. Thus, the system is better equipped to withstand the elevated temperatures experienced in an air brake system.

To further withstand the elevated temperatures of an air brake system, the compressor may be turbo charged or self supercharged which assists in cooling of the compressor. Self supercharging of the compressor is provided by supplying air displaced by the piston at the down stroke to the intake chamber. This air may be used to reduce the temperature of the compressor. To further assist in withstanding the elevated temperatures of the compressor, the crank case 12 and cylindrical bore insert 24 can be fabricated from the same material, such as aluminum. By doing so, heat transfer from the internal bearing assembly to the exterior of the compressor is facilitated, thus reducing the temperature of the bearing assembly.

Still further, the wrist pins 30 in each of the foregoing embodiments is preferably configured to float within the upper housing 42 of the connecting rod. To achieve such a floating feature, at least one PTFE band 80 (see FIG. 7) is provided around the wrist pin. The ball bearings are mounted on these bands. The band does not rigidly connect the wrist pin to the upper housing of the connecting rod. Rather the wrist pin is free to float. As the temperature increases, the band dimensions increase. As the temperature decreases, the band dimensions decrease. The provision of a floating wrist pin prevents undue stress on the wrist pin during the various dynamic motions of the connecting rod.

The invention has been described with reference to the preferred embodiment. Obviously, modifications and alterations will occur to others upon a reading and understanding of the detailed description. For example, any suitable internal path may be provided to deliver oil to the bearing components. Moreover, any suitable sealing components may be used to prevent oil and grease from leaking out of the bearing assemblies. Additionally, materials other than grease may be used to replace oil in the oil-less embodiments. The invention is intended to include all such modifications and alterations insofar as they come within the scope of the accompanying claims and the equivalents thereof.

Having thus described the preferred embodiment, the invention is now claimed to be:

1. A reciprocating compressor for supplying air to an air-actuated vehicle brake system, the reciprocating compressor comprising:
a crank case;
a crank shaft housed by the crank case having a first end and a second end;
a piston assembly housed by the crank case and operatively connected to the crank shaft via a connecting rod, the piston assembly including a piston moveable within a bore of the crank case and a wrist pin rotatably connecting the connecting rod to the piston;
crank shaft bearings operatively associated with the crank shaft and wrist pin bearings operatively associated with the wrist pin;
a channel extending through the crank shaft and connecting rod for delivering oil to the crank shaft and wrist pin bearings; and
first and second sealing assemblies disposed adjacent at least a portion of the crank shaft and wrist pin bearings respectively for preventing oil from escaping into an air stream of the compressor.

2. The compressor of claim 1, wherein the first and second sealing assemblies include lip seals disposed on either side of the crank shaft and wrist pin bearings.

3. The compressor of claim 2, wherein the lip seals are spring loaded for providing a continuous sealing force.

4. The compressor of claim 1, wherein a ceramic coating is disposed on an upper surface of the piston for insulating and reducing the temperature of the lubricated wrist pin bearings and the second sealing assembly.

5. The compressor of claim 1, wherein the wrist pin is at least partially made from zirconium.

6. The compressor of claim 1, wherein the crank case and the bore are both made from aluminum for enhancing heat transfer.

7. The compressor of claim 1, wherein the wrist pin is not rigidly connected to the connecting rod, thereby allowing the wrist pin to float within an upper housing of the connecting rod.

8. The compressor of claim 1, further comprising at least one compression piston ring disposed on a peripheral surface of the piston and sealingly engaging and internal wall of the crank case bore.

9. The compressor of claim 8, wherein the compression piston ring has an out of round shape in its free state and a diameter larger than a diameter of the crank case bore.

10. The compressor of claim 8, wherein the compression piston ring includes a single compression ring.

11. The compressor of claim 1, wherein the compressor is supercharged and air displaced by the piston during supercharging is used to reduce crank shaft and wrist pin bearing temperature.

12. A reciprocating compressor for supplying air to an air-actuated vehicle brake system, the reciprocating compressor comprising:
a crank case;
a crank shaft housed by the crank case having a first end and a second end;
a piston assembly housed by the crank case and operatively connected to the crank shaft via a connecting rod, the piston assembly including a piston moveable within a bore of the crank case, a compression piston ring disposed on a peripheral surface of the piston, and a wrist pin rotatably connecting the connecting rod to the piston; and
crank shaft bearings operatively associated with the crank shaft and wrist pin bearings operatively associated with the wrist pin, the crank shaft bearings being sealed and packed with grease.

13. The compressor of claim 12, wherein the wrist pin bearings are sealed and packed with grease.

14. The compressor of claim 13, wherein the crank shaft bearings include intermediate crank shaft bearings, the intermediate bearings and the wrist pin bearings being sealed with lip seals.

15. The compressor of claim 14, wherein the lip seals are spring loaded for providing a continuous sealing force.

16. The compressor of claim 12, wherein the compression piston ring and the wrist pin bearings are lubricated with oil injected through a passage of the compressor.

17. The compressor of claim 16, wherein the compression piston ring and crank case bore have at least an outer coating made from a ceramic material.

18. The compressor of claim 12, wherein the compression piston ring and the wrist pin bearings are lubricated with one of engine fuel and coolant.

19. The compressor of claim 12, wherein the compressor is supercharged and air displaced by the piston during supercharging is used to reduce crank shaft and wrist pin bearing temperature.

20. A reciprocating compressor for supplying air to an air-actuated vehicle brake system, the reciprocating compressor comprising:
a crank case;
a crank shaft housed by the crank case having a first end and a second end;
a piston assembly housed by the crank case and operatively connected to the crank shaft via a connecting rod, the piston assembly including a piston moveable within a bore of the crank case, a compression piston ring disposed on a peripheral surface of the piston, and a wrist pin rotatably connecting the connecting rod to the piston; and
a means for providing an air stream free of oil.

21. The compressor of claim 20, wherein the means for providing an oil free air stream includes:
a channel extending through the crank shaft and connecting rod for delivering oil to crank shaft bearings and wrist pin bearings associated with the crank shaft and the wrist pin respectively; and
first and second sealing assemblies disposed adjacent at least a portion of the crank shaft and wrist pin bearings respectively.

22. The compressor of claim 20, wherein the means for providing an oil free air stream includes sealed crank shaft bearings and sealed wrist pin bearings packed with grease.

23. The compressor of claim 20, wherein the means for providing an oil free air stream includes sealed crank shaft bearings packed with grease and the compression piston ring and the wrist pin bearings being lubricated with a lubricant injected through a passage of the compressor.

24. A method of providing an oil free air stream from an oil-less/oil free air brake compressor comprising the steps of:
providing a lubricant to wrist pin bearings and crank shaft bearings of the oil-less/oil free compressor; and
sealing the lubricant from escaping into the air stream of the oil-less/oil free compressor.
